(19) United States
(12) Patent Application Publication
(10) Pub. No.: US 2005/0059771 A1
(43) Pub. Date: Mar. 17, 2005

(54) Polyisoprene emulsion, latex articles and processes for preparing thereof

(76) Inventor: Zong-Qiu Su, Shanghai (CN)

Correspondence Address: Raymond Y. Chan, Suite 128, 108 N. Ynez Ave., Monterey Park, CA, 91754, US

(21) Appl. No.: 10/769,698

(22) Filed: Jan. 30, 2004

(30) Foreign Application Priority Data
Sep. 17, 2003 (CN) 03151008.6

(51) Int. Cl. C08K 3/00

(52) U.S. Cl. 524/570

(57) ABSTRACT

A polyisoprene emulsion is provided, being made from 60˜100 parts by weight of isoprene monomer and 5˜50 parts by weight of one or more monomers selected from the group consisting of styrene, acrylates and organic acids, by using a free radical emulsion polymerization in the presence of an emulsifier and an initiator, said polyisoprene emulsion having a weight average molecular weight of 10⁴˜10⁵, pH of 6.0˜7.0, viscosity of 5˜20 cp (25° C.), solid content of 30˜50%, and colloidal particle size of 100˜200 nm. The polyisoprene emulsion thus obtained has excellent film-forming property; the latex articles made therefrom are suitable for use in the areas of medicine-hygiene, electronic industries, science and technology for national defense, and daily life.

### BACKGROUND OF THE PRESENT INVENTION

1. Field of Invention

The present invention relates to latex articles, particularly relates to polyisoprene latex articles as well as the manufacturing method for preparing polyisoprene emulsion and latex articles.

2. Description of Related Arts

For the reasons of environment issues and health care concerns, strict standards and more detailed requirements have been put forward on the production, application and recovery of disposable products, especially organic disposable products in recent years. Those pollution-causing products, failed to meet new environment-protecting threshold, are undoubtedly doomed to be gradual eliminated from our society.

Nowadays, a variety of disposable latex articles such as clinical gloves are quite common in our routine practices. For instance, PVC gloves and latex gloves including natural latex gloves, synthetic latex gloves, as well as latex gloves made from a combination of natural and synthetic thereof, have been applied in various practices, such as daily life, medicine-hygiene, national defense-military, electronic monitoring, and the like.

Thanks to its high strength and low cost characteristics, PVC articles have been welcomed in medical and routine practices. However, PVC articles suffered severe drawbacks, such as degradation resistance, environmental pollution, poor air permeability resulting to uncomfortable sense of touch, and the inconformity with environment protection requirements in producing and waste treating process, etc. So, some developed countries already enacted laws to regulate, even prohibit the use and production of PVC gloves.

On the other hand, the low cost natural latex products have been widely used as condoms, and gloves applied in surgery, industry, household, insulating practices. However, natural latex contains casein, which tends to cause skin hypersensitivity and produce an irritating smell.

Synthetic latex mainly includes chloroprene rubber, butadiene-nitrile rubber, vinyl chloride-styrene rubber, styrene-butadiene rubber, and the blends thereof or the copolymers thereof. These latex products do not have the skin hypersensitivity problem caused by casein. Furthermore, compared with natural latex products, synthetic latex are superior in the properties such as resistances to oils and chemicals, resistances to oxidation and ozonization, low permeation, and penetration resistance. In addition, they have the same hand feeling as the natural latex products. Of these, chloroprene rubber and butadiene-nitrile rubber latex products have been manufactured with an industrialized scale. However, the problems in the recovery treatment for chloroprene latex products and the irritating smell of butadiene-nitrile latex and its articles have obstructed the extension of their applications.

The application of polyisoprene, prepared by using ionic solution polymerization, in the rubber has been intensively investigated. Polyisoprene latex products, prepared by using free radical emulsion polymerization, have advantages of high strength, good appearance and hand feeling, and relatively low cost, but are slightly low in the film-forming property. Therefore, it is expectable within the art to develop a manufacturing method to produce polyisoprene latex gloves, in which the advantages of polyisoprene are maximally employed, while its shortcomings could be minimized.

There have been reports on natural and synthetic latexes and products thereof. These latexes can be formulated in combination to form a single film, or to form multiple-layer films with different latexes. It was reported in Japanese Patent Publication No. 09310209 (1997) that latex gloves, produced by dipping in a combination of a de-protein natural latex and a butadiene-nitrile latex, had properties of oil resistance and no yellowing. It was disclosed in Japanese Patent Publications No. 11081014 (1999) and 200199112 (2000) that the addition of colloidal silica into the natural latex had improved the ripping resistance and releasability of the latex gloves. It was reported in WO 9924507 that the combination of chloroprene latex and butadiene-nitrile latex showed a good dipping elastic resilience without hypersensitivity problem. In addition, the utilization of hydrated inorganic salts as a flame retardant for butadiene-methyl methacrylate latex foaming rubber was described in EP 744418. Moreover, it was reported in U.S. Pat. No. 5,985,955 (1999) that coating polyurethane onto the surface of natural latex articles forms gloves having water-proof and organic solvent resistant properties. Polyacrylate emulsion has been widely applied in coatings and the specific properties thereof can be used in latex gloves to improve their performance and widen the application scope thereof.

All the literatures mentioned above are incorporated herewith in their entirety for reference.

### SUMMARY OF THE PRESENT INVENTION

A main object of present invention is to provide polyisoprene latex articles, wherein advantage properties of polyioprene are employed.

Another object of the present invention is to provide a polyisoprene emulsion for preparing polyisoprene latex articles.

Another object of the invention is to provide a manufacturing method for preparing the polyisoprene emulsion.

Another object of the present invention is to provide a manufacturing method for preparing latex articles from polyisoprene emulsion.

Accordingly, to accomplish the above objects, the present invention provides a polyisoprene emulsion, latex articles, which is made from 60-100 parts by weight of isoprene monometer and 5-50 parts by weight of one or more monometers selected from a group consisting of styrene, acrylates, and organic carboxylic acids, having a weight average molecular weight of 10⁴˜10⁵, pH of 6.0-7.0, viscosity of 5-20 cp(25° C.), solid content of 30-50%, and colloidal size of 100-200 nm.

Furthermore, the present invention provides a polyisoprene emulsion products manufacturing method comprising the steps of:
(a) Preparing an aqueous polyisoprene emulsion by using a free radical emulsion polymerization under a normal pressure or by using a co-polymerization added with other manometers;
(b) Blending water-dispersible vulcanization auxiliaries with aqueous polyisoprene emulsion to form blended polyisoprene emulsion;
(c) Aging the blended polysoprene emulsion;
(d) Adding setting agent into aged polysoprene emulsion; and
(e) Dip-molding blended polyisoprene emulsion into polyisoprene latex articles.

These and other objectives, features, and advantages of the present invention will become apparent from the following detailed description, the accompanying drawings, and the appended claims.

### BRIEF DESCRIPTION OF THE DRAWINGS

FIG. 1 is a table showing the components and ratios for preparing polyisoprene latex in example 1.

FIG. 2 is a table showing the components and ratios for preparing polyisoprene latex in example 2.

FIG. 3 is a table showing the components and ratios for preparing polyisoprene latex in example 6.

FIG. 4 is a table showing the components and ratios for preparing polyisoprene latex in example 7.

FIG. 5 is a table showing the components and ratios for preparing polyisoprene latex in example 8.

### DETAILED DESCRIPTION OF THE PREFERRED EMBODIMENT

According to the preferred embodiment of the present invention, the manufacturing method for preparing polyisoprene emulsion articles comprises the steps of:
(a) Preparing an aqueous polyisoprene emulsion by using a free radical emulsion polymerization under a normal pressure or by using a co-polymerization added with other monometers;
(b) Blending water-dispersible vulcanization auxiliaries with aqueous polyisoprene emulsion to form blended polyisoprene emulsion;
(c) Aging the blended polysoprene emulsion;
(d) Adding setting agent into aged polysoprene emulsion; and
(e) Dip-molding blended polyisoprene emulsion into polyisoprene latex articles.

In the step (a), polyisoprene emulsion could be prepared by a free radical emulsion polymerization under a normal pressure or by co-polymerization through adding other monometers selected from a group consisting of styrene, acrylates and organic carboxylic acids to prepare a co-polymerized aqueous polyisoprene emulsion.

And the step (a), according to the preferred embodiment of present invention, further comprises the following steps:
(1) Charging a portion of the monomers together with the initiator and the emulsifier into a reactor;
is (2) Reacting the mixture for 30˜60 min. at a room temperature or under a gentle heating;
(3) Adding dropwise the remaining monomers and other raw materials into the reactor for 3˜6 hours.
(4) Reacting the mixture under a nitrogen atmosphere for 12˜40 hours.

It is thus clear the manufacturing method here adapts a semi-continuous load manner, namely, a portion (for example, 10%) of the monomers is firstly charged along with the initiator and the emulsifier into a reactor and the mixture is reacted for 30˜60 min at room temperature or under gentle heating; then the remaining monomers and other raw materials are added dropwise into the reactor for 3-6 hours, and the reaction is carried out under a nitrogen atmosphere for 12-40 hours.

According the preferred embodiment, monomers are made from 60˜100 parts by weight of isoprene (IP) monomers and 5˜50 parts by weight of one or more monomers selected from the group consisting of styrene, acrylates and organic carboxylic acids. Meanwhile, in analysis the final products, the polyisoprene emulsion has a weight average molecular weight of 10⁴˜10⁵, pH of 6.0˜7.0, viscosity of 5˜20 cp (25° C.), solid content of 30˜50%, and colloidal particle size of 100˜200 nm.

The acrylate is one or more compounds selected from a group consisting of methyl acrylate (MA), ethyl acrylate (EA), butyl acrylate (BA), iso-octyl acrylate (EHA), methyl methacrylate (MMA), and butyl methacrylate (BMA).

The organic carboxylic acid is one or more compounds selected from a group consisting of acrylic acid (AA), methacrylic acid (MAA), maleic acid, fumaric acid, and methylenebutene dicarboxylic acid.

The emulsifier used in step (1) for preparing the polyisoprene emulsion according to the preferred embodiment of present invention is a combination of an anionic emulsifier and a non-ionic emulsifier. The anionic emulsifier is selected from sodium dodecyl sulfate (SDS), sodium dodecanesulphonate, OS emulsifier, and the like; the non-ionic emulsifier is nonylphenol polyethylene glycol oxide, such as OP-10. It is also possible to use anionic emulsifier alone, without using non-ionic emulsifier. The amount of the emulsifier used is 3˜50%(by weight), based on the total amount of the monomers; and the preferred amount is 5˜30%(by weight), based on the total amount of the monomers.

The initiator used in step (1) for the polyisoprene emulsion polymerization is a redox system, wherein the oxidant can be a water-soluble persulfate, such as ammonium persulfate, potassium persulfate, etc.; alternatively, it can be an oil-soluble peroxide, such as benzoyl peroxide (BPO), isopropylphenyl hydroperoxide, and the like; the reductant can be sodium bisulfite, iron(II) sulfate, and the like. The amount of the initiator used is 0.1˜5%(by weight), based on the total amount of monomers, and the preferred amount is 0.3˜3%(by weight), based on the total amount of monomers.

According to the preferred embodiment of present invention, in the step (a) for polymerizing isoprene emulsion, a co-reductant, a complexing agent and a precipitating agent, etc. are usually added to maintain the concentration of the ferrous iron (II) ion for ensuring a steady reaction. Typical co-reductant includes formaldehyde sulfoxylate (rongalite); the complexing agent can be ethylenediamine trtraacetic acid (EDTA); and the precipitating agent can be pyrophosphates.

In the step (b), water dispersible vulcanization auxiliaries are added into the polyisoprene emulsion. Said auxiliaries include vulcanizators, vulcanization accelerators, age inhibitors, and the like. Here, said vulcanizator is sulfur; said vulcanization accelerator includes sulfenamides and thiurams with an amounts of 0.5˜10% (by weight), based on the amount of the polyisoprene emulsion. And, the preferred amounts of vulcanization accelerator are 1˜5% (by weight), based on the amount of the polyisoprene emulsion.

In the step (c), vulcanized polyisoprene emulsion is disposed standing for ageing process.

In the step (d), setting agent is added for products formation wherein said setting agent is composed of cationic salts and auxiliaries. The cation is selected from the group consisting of hydrochlorides or nitrates of calcium ion, zinc ion, and aluminum ion. The amount of the setting agent used is 5˜40% (by weight), based on the amount of the polyisoprene emulsion, and the preferred amount is 10˜30% (by weight).

Finally, in the step (e), various moulds are dipped with the polyisoprene emulsion to form final products. according to the preferred embodiment of present invention, final products are dried at 60˜170° C., being cured into shapes to afford corresponding articles having a thickness of film from 0.05 mm to 0.50 mm, a tensile strength of film greater than 8 Mpa, and an elongation rate of film greater than 800%.

So, the polyisoprene latex articles made according to this manufacturing method could be qualified all objects of the present invention, thereby are capable of being used as clinical gloves, industrial gloves, house-hold gloves, condoms, insulating gloves, and the like.

The invention is further illustrated by the following examples, but these examples are not intended to limit the invention. All of the modifications and variations made by those skilled in the art following the teaching of the description should fall within the scope of the appended claims.

### EXAMPLE 1

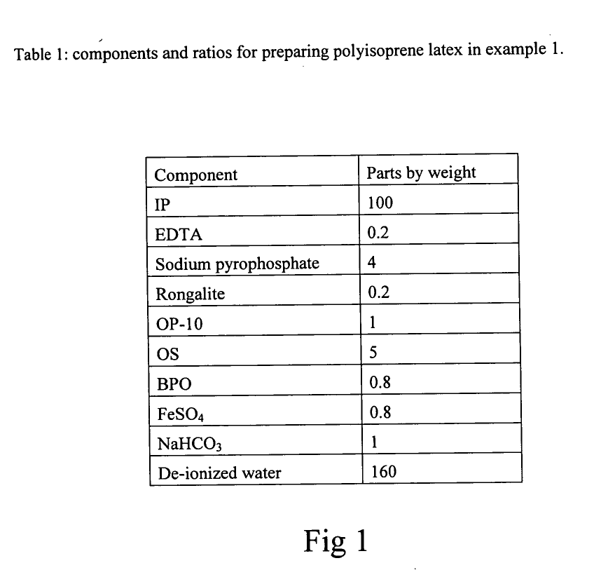

Table 1 as shown in FIG. 1 shows the components and ratios for preparing aqueous polyisoprene latex.

In this example, 1/10 amount of IP and BPO, ⅔ amount of emulsifier, 1/10 amount of FeSO₄ and entire amounts of sodium pyrophosphate, EDTA, SFS and NaHCO₃, and a suitable amount of de-ionized water were added into a 500 mL four-necked flask, equipped with a stirrer, a reflux condenser, a thermometer and a nitrogen inlet, were. The mixture was stirred at room temperature for 30 min, and then reacted in a water bath at 30° C. constant temperature for another 30 min. Over 3˜6 hours, under nitrogen atmosphere protection, a mixture of the remaining amount of IP, MAA and BPO along with the remaining amount of the emulsifier and initiator was simultaneously added dropwise. After addition, the reaction was continued for 12˜40 hours, then the excess monomers were removed by strong nitrogen flush to obtain a stable white emulsion having pH of 6.2, solid content of 34.0%, and viscosity of 12 cp (25° C.).

By ionic deposition method with a calcium nitrate type setting agent, a ceramic hand mould was dip-molding in the emulsion. The film formed from this emulsion was too thin to release from the mould.

Afterwards, 100 Parts by weight of such obtained polyisoprene emulsion was added into a 400 mL beaker. And then 2.5 parts by weight of sulfur, 1 part by weight of age resister, 2 parts by weight of accelerator, and 2 parts by weight of zinc oxide were added slowly into the beaker. Simultaneously, the mixture was stirred at 200 rpm to thoroughly mix the emulsion with the auxiliaries. By ionic deposition method with a calcium nitrate type setting agent, a ceramic hand mould was dip-molding in the emulsion. After drying at 60˜170° C., transparent latex gloves obtained with a film-thickness of 0.13 mm, a modulus at 500% elongation of 7.0 Mpa. The film has good hand feeling and high elastic resilience.

### EXAMPLE 2

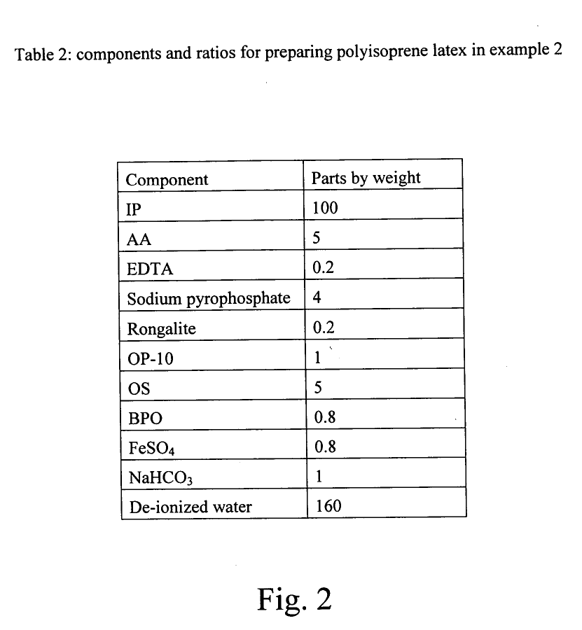

Table 2 as shown in FIG. 2 shows the components and ratios for preparing aqueous polyisoprene latex.

Similar to Example 1, a stable white emulsion was obtained, having pH of 6.1, solid content of 34.2%, and viscosity of 12 cp (25° C.). This emulsion can directly be dip-molded without vulcanization and the film articles prepared therefrom have good performances.

By ionic deposition method with a calcium nitrate type setting agent, a ceramic hand mould was dip-molding in the emulsion. After drying at 60˜170° C., transparent latex gloves were obtained with a film-thickness of 0.13 mm, a modulus at 500% elongation over 8.0 Mpa. The film has a good hand feeling and high elastic resilience.

### EXAMPLE 3

The procedure was similar to that in Example 2, except using equivalent MAA in place of AA, to obtain a white latex having pH of 6.5, solid content of 35% and viscosity of 13 cp (25° C.), and the film articles therefrom having a film thickness of 0.13 mm and a modulus at 500% elongation over 8.5 Mpa, with high elastic resilience.

### EXAMPLE 4

The procedure was similar to that in Example 2, except using equivalent fumaric acid in place of AA, to obtain a white latex having pH of 6.5, solid content of 35% and viscosity of 13 cp (25° C.), and the film articles therefrom having a film thickness of 0.13 mm and a modulus at 500% elongation of 7.8 Mpa, with a good hand feeling and high elastic resilience.

### EXAMPLE 5

The procedure was similar to that in Example 2, except using equivalent methylene butene dicarboxylic acid in place of AA, to obtain a white latex having pH of 6.4, solid content of 35.2% and viscosity of 14 cp (25° C.), and the film articles therefrom having a film thickness of 0.14 mm and a modulus at 500% elongation of 8.2 Mpa, with high elastic resilience.

### EXAMPLE 6

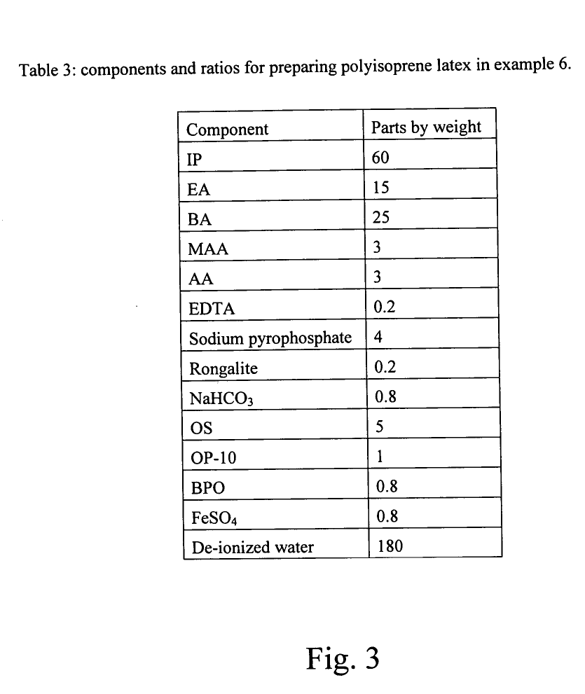

Table 3 as shown in FIG. 3 shows the components and ratios for preparing aqueous polyisoprene latex.

1/10 amount of IP, EA, BA, AA, MAA and BPO, ⅔ amount of emulsifier, 1/10 amount of FeSO₄ and entire amounts of sodium pyrophosphate, EDTA, SFS, NaHCO₃ and a suitable amount of de-ionized water were added into a 500 mL four-necked flask equipped with a stirrer, a reflux condenser, a thermometer and a nitrogen inlet were added. Afterwards, the mixture was stirred at room temperature for 30 min, then reacted in a water bath at 30° C. constant temperature for another 30 min. Over 3˜6 hours, under nitrogen atmosphere protection, a mixture of the remaining monomers along with the remaining emulsifier and initiator were simultaneously added dropwise. After addition, the reaction was continued for 12˜40 hours, then the excess monomers were removed by strong nitrogen flush to obtain a stable white emulsion having pH of 6.4, solid content of 34.8% and viscosity of 14 cp (25° C.), and the film articles prepared therefrom having a film thickness of 0.13 mm and a modulus at 500% elongation of 6.8 Mpa with high elastic resilience.

### EXAMPLE 7

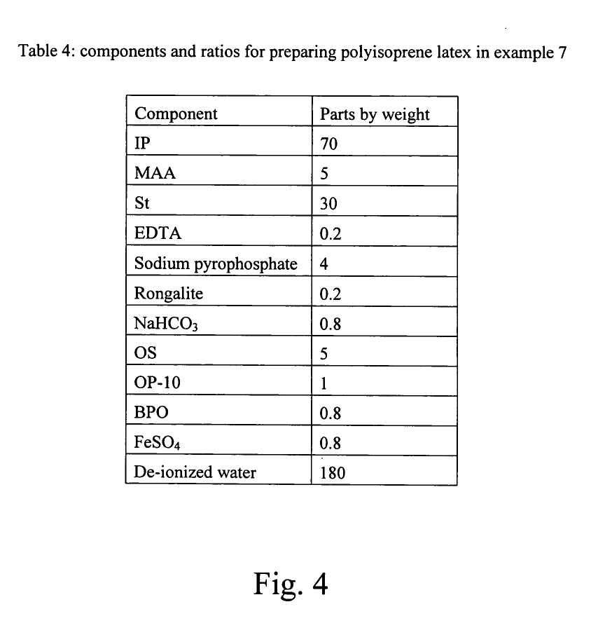

Table 4 as shown in FIG. 4 shows the components and ratios for preparing aqueous polyisoprene latex.

By using the method similar to that in Example 6, a white latex was obtained, having pH of 6.4, solid content of 35%, viscosity of 15 cp (25° C.), and the film articles prepared therefrom having a film thickness of 0.14 mm and a modulus at 500% elongation of 7.4 Mpa, with high elastic resilience.

### EXAMPLE 8

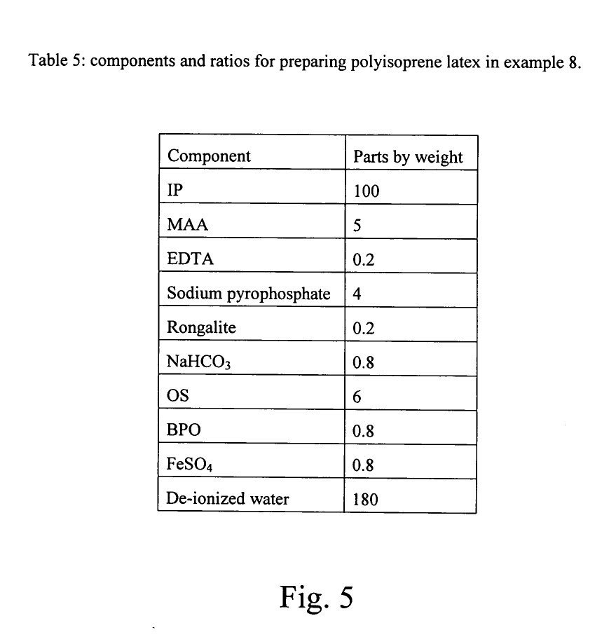

Table 5 as shown in FIG. 5 shows the components and ratios for preparing aqueous polyisoprene latex.

By using the method similar to that in Example 6, a white latex was obtained, having pH of 6.4, solid content of 35%, viscosity of 15 cp (25° C.), and the film articles prepared therefrom having film thickness of 0.14 mm and modulus at 500% elongation of 8.5 Mpa, with high elastic resilience.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. A method for preparing polyisoprene emulsion articles comprises the steps of.
(a) Preparing an aqueous polyisoprene emulsion;
(b) Blending water-dispersible vulcanization auxiliaries with said aqueous polyisoprene emulsion to form a blended polyisoprene emulsion;
(c) Aging said blended polyisoprene emulsion;
(d) Adding setting agent into said blended polyisoprene emulsion; and
(e) Dip-molding said blended polyisoprene emulsion into polyisoprene latex articles.

2. the method, as recited in claim 1, wherein said polyisoprene emulsion in said step (a) is prepared by a free radical emulsion polymerization from isoprene monometers under a normal pressure.

3. the method, as recited in claim 1, wherein said polyisoprene emulsion in said step (a) is prepared by a co-polymerization through mixing monometers selected from a group consisted of styrene, acrylates and organic carboxylic acid with isoprene monometers;

4. the method, as recited in claim 3, wherein said acrylate is one or more compounds selected from a group consisting of methyl acrylate (MA), ethyl acrylate (EA), butyl acrylate (BA), iso-octyl acrylate (EHA), methyl methacrylate (MMA), and butyl methacrylate (BMA).

5. the method, as recited in claim 3, wherein said organic carboxylic acid is one or more compounds selected from a group consisting of acrylic acid (AA), methacrylic acid (MAA), maleic acid, fumaric acid, and methylenebutene dicarboxylic acid.

7. The method, as recited in claim 2, wherein the step (a) further comprises the steps of:
(1) Charging a portion of said monomers together with an initiator and an emulsifier into a reactor to form a mixture;
(2) Reacting said mixture for 30˜60 min. at a room temperature or under a gentle heating;
(3) Adding dropwise remaining portion of said monomers and other raw materials into said reactor for 3˜6 hours.
(4) Reacting said mixture under a nitrogen atmosphere for 12˜40 hours.

8. The method, as recited in claim 6, wherein the step (a) further comprises the steps of:
(1) Charging a portion of said monomers together with an initiator and an emulsifier into a reactor to form a mixture;
(2) Reacting said mixture for 30˜60 min. at a room temperature or under a gentle heating;
(3) Adding dropwise remaining portion of said monomers and other raw materials into said reactor for 3˜6 hours.
(4) Reacting said mixture under a nitrogen atmosphere for 12˜40 hours.

9. The method, as recited in claim 7, wherein said emulsifier in said step (1) is a combination of an anionic emulsifier and a non-ionic emulsifier, said anionic emulsifier is selected from a group consisting of sodium dodecyl sulfate (SDS), sodium dodecanesulphonate, and OS emulsifier, and said non-ionic emulsifier is nonylphenol polyethylene glycol oxide.

10. the method, as recited in claim 7, wherein a preferred amount of said emulsifier used in said step (1) is 5-30%(by weight), based on total amounts of said manometers.

11. the method, as recited in claim 8, wherein said emulsifier in said step (1) is a combination of an anionic emulsifier and a non-ionic emulsifier, said anionic emulsifier is selected from a group consisting of sodium dodecyl sulfate (SDS), sodium dodecanesulphonate, and OS emulsifier, and said non-ionic emulsifier is nonylphenol polyethylene glycol oxide.

12. the method, as recited in claim 8, wherein a preferred amount of said emulsifier used in said step (1) is 5-30%(by weight), based on total amounts of said manometers.

13. The method, as recited in claim 7, wherein said initiator used in said step (1) a redox system, wherein an oxidant is selected from a group consisting of a water-soluble persulfate and an oil-soluble peroxide; wherein a reductant is selected from a group consisting of sodium bisulfite, iron(II) sulfate; wherein a preferred amount of said initiator is 0.3-3%(by weight) based on a total amounts of said monometers.

14. the method, as recited in claim 7, wherein said step (a) further comprises a step adding a co-reductant, a complexing agent and a precipitating agent to maintain a concentration of a ferrous iron (II) ion for ensuring a steady reaction, wherein said co-reductant includes formaldehyde sulfoxylate (rongalite), said complexing agent is ethylenediamine trtraacetic acid (EDTA), and said precipitating agent is pyrophosphates.

15. the method, as recited in claim 7, wherein said water-dispersible vulcanization auxiliaries in said step (b) is selected from a group consisting of vulcanizators, vulcanization accelerators, age inhibitors, and the like; wherein said vulcanizator is sulfur; said vulcanization accelerator includes sulfenamides and thiurams with an amounts of 0.5˜10% (by weight); wherein a preferred amount of said vulcanization accelerator is 1˜5% (by weight), based on an amount of said polyisoprene emulsion.

16. the method, as recited in claim 8, wherein said water-dispersible vulcanization auxiliaries in said step (b) is selected from a group consisting of vulcanizators, vulcanization accelerators, age inhibitors, and the like; wherein said vulcanizator is sulfur; said vulcanization accelerator includes sulfenamides and thiurams with an amounts of 0.5˜10% (by weight); wherein a preferred amount of said vulcanization accelerator is 1˜5% (by weight), based on an amount of said polyisoprene emulsion.

17. the method, as recited in claim 7, wherein said setting agent used in said step (d) is a mixture of cationic salts and auxiliaries, wherein said cationic salts is selected from a group consisting of hydrochlorides and nitrates of calcium ion, zinc ion, and aluminum ion; wherein a preferred amount of said setting agent is 10-30% (by weight) base on an amount of said polyisoprene emulsion.

18. the method, as recited in claim 8, wherein said setting agent used in said step (d) is a mixture of cationic salts and auxiliaries, wherein said cationic salts is selected from a group consisting of hydrochlorides and nitrates of calcium ion, zinc ion, and aluminum ion; wherein a preferred amount of said setting agent is 10-30% (by weight) base on an amount of said polyisoprene emulsion.

19. The method, as recited in claim 7, wherein said step (e) furthering comprises a step for dring said polyisoprene articles at 60˜170° C.

20. A polyisoprene emulsion, having a weight average molecular weight of weight of 10⁴˜10⁵, pH of 6.0-7.0, viscosity of 5-20 cp (25° C.), solid content of 30-50%, and colloidal size of 100-200 nm.

21. The polyisoprene emulsion, as recited in claim 20, being made from 60-100 parts by wight of isoprene monometer and 5-50 parts by weight of one or more monometers selected from a group consisting of styrene, acrylates, and organic carboxylic acids.

22. The polyisoprene emulsion article, as recited in claim 21, containing 10-50% said styrene by weight.

23. The polyisoprene emulsion, as recited in claim 21, containing 10-50% said acrylate by weight.

24. The polyisoprene emulsion, as recited in claim 21, containing 1-10% said organic carboxylic acids by weight.

25. A polyisoprene latex article, having a weight average molecular weight of weight of 10⁴˜10⁵, pH of 6.0-7.0, viscosity of 5-20 cp (25° C.), solid content of 30-50%, and colloidal size of 100-200 nm.

26. The polyisoprene latex article, as recited in claim 25, being made from 60-100 parts by wight of isoprene monometer and 5-50 parts by weight of one or more monometers selected from a group consisting of styrene, acrylates, and organic carboxylic acids.
